(19) United States
(12) Patent Application Publication
(10) Pub. No.: US 2002/0062341 A1
(43) Pub. Date: May 23, 2002

(54) Interested article serving system and interested article serving method

(76) Inventors: Genichiro Sueki, Kamakura-shi (JP); Hiroaki Fujiki, Kamakura-shi (JP); Naoko Yoshino, Kamakura-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/973,024

(22) Filed: Oct. 10, 2001

(30) Foreign Application Priority Data
Nov. 17, 2000 (JP) 2000-351144

(51) Int. Cl. G06F 15/16

(52) U.S. Cl. 709/203; 709/219

(57) ABSTRACT

An interested article serving system includes a client device and a server device, serving an information in accordance with a request from the client device, connected through a network system. The server device comprises a WWW server section operating in response to the requirement from the client device, a data base server section storing personal information and access history of a client using the client device, an interested article extraction server section analyzing the access history of the client stored in the data base server section and then producing a search condition equation, and a superparallel computer searching article data sequentially fed from an external article producing computer in accordance with the search condition equation produced in the interested article extraction server section. In such system, a plurality of different search condition equations are set individually on a plurality of different processors of the superparallel computer, the article data is subjected to full text search and a result coincident with the search condition equations is transmitted to the client device.

### BACKGROUND OF THE INVENTION

The present invention relates to a system for serving and distributing interested articles, news, informations, data and the like, called herein as articles or article for the sake of convenience, and a method of serving the articles through a network service, in which when clients receive articles interested by them, only articles which are interested by the client are automatically selected and obtained, and upon the obtaining of such articles, only these articles can be immediately served or distributed to the clients.

In prior art, various kinds and types of article serving (distributing) services have been carried out and executed through internet system, and in general, the articles are served through processes of edition or classification on the provider.

Particularly, in a computer having a general data base system, when an article to be indexed is inputted into the data base, it is necessary to perform indexing process so as to add, as an index, a word having characteristics as a keyword at the time of indexing the article, and for this reason, it is difficult to instantaneously serve an article at the time of obtaining a new article.

The general service of a server for serving an interested article to a client is performed, in accordance with category or keyword designated by a client, by indexing or searching the articles included in that category or including that keyword and then serving the article(s) satisfying the searching (indexing) condition through serving means such as electronic mail or like. However, when the articles are designated in accordance with the unit of category, all the articles included in that category are distributed. These articles will include articles not interested by the client, and otherwise, in a case where a client has a plurality of interests, extremely large number of articles will be served to the client.

On the other hand, the keyword is designated by the client, all the articles including such keyword will be distributed to the client, which include articles not interested by the client. In another case where the client is not familiar with setting or handling of such keyword, it was difficult for the client to obtain only the desired articles.

Moreover, in recent days, there have been developed methods or techniques of analyzing interests of a client on the basis of access history of the client. However, the conventional methods or techniques have been performed on the basis of the provision that the interest of the client is qualitative and are not suitable for being operated in accordance with change in the time elapsing.

Generally, almost all the interests which are to be known by clients in real time are matters concerning topics or events such as Olympic Game which have presently picked up and which will be forgotten in the time elapsing. Recently, in fact, there has been developed a system in which an article, to which referring times and clicking times, as parameters, are made much time, is the article most interested. However, in such system, it will be not said that the number of the referring times or clicking times to the article recently interested always exceeds that to an article past interested.

Furthermore, as a method of automatically extracting a keyword indicating interest of a client based on the access history, there is provided a method of calculating appearance frequency of all articles concerning the keyword and a ratio of appearance (great criticality or significancy) of that keyword in the articles and then multiplying them as weight. In such method, however, there may cause a possibility of outputting deviated tendency according to the articles. For example, in a case where a keyword having large significancy appears several times in an article which has been unexpectedly once accessed, the article would be deemed as an interested article even if it not be interested, thus providing a problem.

### SUMMARY OF THE INVENTION

An object of the present invention is to substantially eliminate defects or problems encountered in the prior art mentioned above and to provide system and method of instantaneously serving or distributing articles interested by clients, with no necessity of setting categories or keywords by the clients, by extracting articles interested by the clients automatically with no specific consciousness of the clients.

Another object of the present invention is, in a method of designating an article interested by the client, to provide system and method of instantaneously serving or distributing articles interested by clients, by designating the entire article in which information interested by the client is described without being designated by means of keyword.

These and other objects can be achieved according to the present invention by providing, in one aspect, an interested article serving system in which a client device and a server device serving an information in accordance with a request from the client device are connected through a network system, the server device comprising:

a WWW server section operating in response to the requirement from the client device;

a data base server section storing personal information and access history of a client using the client device;

an interested article extraction server section analyzing the access history of the client stored in the data base server section and then producing a search condition equation; and

a superparallel computing means searching article data sequentially fed from an external article producing computer in accordance with the search condition equation produced in the interested article extraction server section,

wherein a plurality of different search condition equations are set individually on a plurality of different processors of the superparallel computing means, the article data is subjected to full text search and a result coincident with the search condition equations is transmitted to the client device.

According to the system of this aspect, it is not necessary to set a category or keyword by a client, and it becomes possible to extract automatically an interest of the client and instantaneously serve or provide the interested article to the client with no specific consciousness of the client.

In preferred examples of this aspect, the article data is received from an external article production computer other than the server device.

The access history is accumulated for each of clients and when the client accesses a plurality of articles, in a plurality of times, resembling in contents as the access history, a natural language included in plurality of articles having resembling contents is used as a search keyword of the search condition equation.

Otherwise, the access history is accumulated for each of clients and when the client accesses a plurality of articles, in a plurality of times, different in contents as the access history, constant number of articles or number of articles which are accessed in a constant term is determined as reference number of articles, and same natural languages appearing in a plurality of articles having different contents in the reference number of articles are used as a search keyword of the search condition equation. The search condition equation adopts a characteristic natural language as the search keyword which is weighed by number of appearance of the natural language in the specified article data designated by the client and a ratio of appearance of the natural language in a plurality of articles included in the access history of the client.

The access history is accumulated for each of clients, and when the client designates a specific article data as the access history, a natural language included in the specific article data is used as a search keyword of the search condition equation.

The client device is a portable terminal device such as portable telephone.

According to these preferred examples, since an article serving system managed by an existing article serving organization can be utilized as an information source of an article data, time and cost involved for newly constructing an article data base can be eliminated. Furthermore, in a case where an existing article serving organization utilizes the present invention, a new additional value will be provided to a client.

In the case where the natural language included in plurality of articles having resembling contents is used as a search keyword of the search condition equation, only the articles interested by the client can be automatically distributed to the client without designating the search conditions. Furthermore, in the case where the same natural languages appearing in a plurality of articles having different contents in the reference number of articles are used as a search keyword of the search condition equation, only the articles interested by the client can be also automatically distributed to the client without designating the search conditions.

Since the client device may be a portable terminal device such as portable telephone, the client can easily obtain the necessary interested article at any time and at any place.

In another aspect of the present invention, there is provided an interested article serving method using a serving system in which a client device and a server device serving an information in accordance with a request from the client device are connected through a network system, the serving method comprising the steps of:

analyzing an access history of a client using the client device and then producing a plurality of different search condition equations;

setting a plurality of different search condition equations independently on a plurality of different processors included in a superparallel computer means;

searching simultaneously parallelly a full text of an article data subsequently fed from an external article producing computer with a plurality of different search condition equations; and

serving a result which coincident with the search condition equation to the client device.

According to this aspect, it is not necessary for the client to set a category or keyword for articles, and it becomes possible to extract automatically an interest of the client and instantaneously serve or provide the interested article to the client with no specific consciousness of the client, as mentioned above.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is a block diagram representing an interested article serving system according to one embodiment of the present invention;

FIG. 2 is a diagram showing an internal processing of a superparallel computer included in a server device of the interested article serving system of FIG. 1;

FIG. 3 is a flowchart showing procedures in a case of using the interested article serving system of FIG. 1;

FIG. 4 is an image view of a device of a client in the interested article serving system of the present invention;

FIG. 5 is a flowchart showing procedures for automatically producing a search condition equation from a designated article content; and

FIG. 6 is a flowchart showing procedures for statistical processing and automatic production of a search condition equation based on this processing in the interested article serving system of the present invention.

### DESCRIPTION OF THE PREFERRED EMBODIMENTS

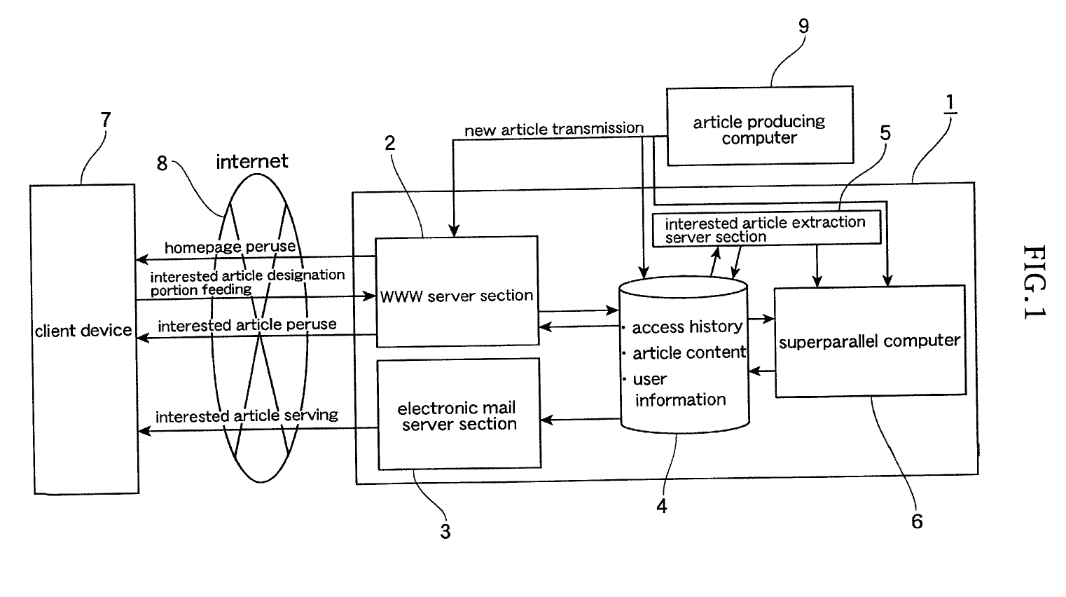

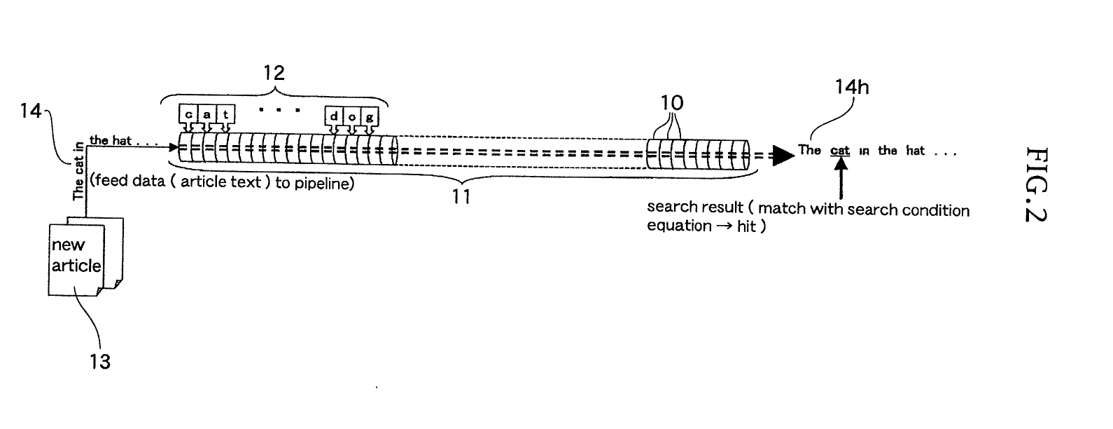

One preferred embodiment of a system for serving or distributing an interested article of the present invention will be described hereunder with reference to FIGS. 1 and 2.

As mentioned above, FIG. 1 is a block diagram representing an interested article serving system and FIG. 2 is a modeled diagram showing an internal processing of a superparallel computer included in a server device of the interested article serving system of FIG. 1;

Further, it is to be noted that the term “article” used herein may include or be substituted with news, informations, data or the like matters.

Referring to FIG. 1, a server device 1 is generally composed of a computer, which comprises a WWW server section 2, an electronic mail server section 3, a data base server section 4, an interested article extracting server section 5 and a superparallel computer or processor 6.

A client device 7 is a computer to be connected to an internet 8 used by a client, and a client peruses a homepage, designates an interested article and peruses an electronic mail through this client device 7. The client device 7 may be a portable terminal device such as portable telephone or like capable of being connected to the internet 8 or being served with electronic mail service.

An article producing computer 9 is a computer for recording a newly generated article into the WWW server section 2 of the server device 1 by an external article serving (distributing) system or organization, and the newly generated article is transferred simultaneously parallelly to the superparallel computer 6 and/or the data base server section 4 of the server device 1.

The interested article extracting server section 5 is connected to the data base server section 4 and the superparallel computer 6 connected to this data base server section 4 and has a function to automatically produce a searching (indexing) condition equation from an access history of an client or an article interested by the client.

The superparallel computer 6 includes, as shown in FIG. 2, several or several tens of processors 10 (called totally as “pipeline” hereinlater), and has a function capable of simultaneously setting a plurality of different indexing condition equations 12 in this pipeline. When a new article 13 is transmitted from the article producing computer 9 through the simultaneous operation of a number of these processors, an article data is fed to the pipeline 11 and full text search is executed for performing a matching between a plurality of different search condition equations 12 and an article date 14. As a result of such matching operation, when the article data according to the indexing condition equation 12 is found out, such article data 14 is deemed to be hit. The superparallel computer 6 has such functions as mentioned above.

As such superparallel computer 6, it may be desired to utilize an equipment such as full text search engine (for example, FDF (Registered Trade Mark) 4T TextFinder manufactured by Paracel Inc.), but another equipment or device such as work-station having equivalent function and performance may be also utilized.

The WWW server section 2 is provided with a function for transferring an article data 14h obtained as a result of the full text search of the superparallel computer 6 to an address to be served or Web-page designated by the client.

In the data base server section 4, there is stored a history showing that the client peruses a homepage in a most recent predetermined interval or predetermined article numbers per every client as an access history of a client using the client device 7. Furthermore, it may be possible to also store, together therewith, a result of the statistical processing of natural language having high interest of each client and its significancy. Further, it may be possible that clients are classified into and then defined as clients who require the article distribution service and clients who do not require such article distribution service for the purpose of saving access history area, and for the clients who do not want such service, only the peruse history of the homepage is stored.

The article data is composed of article title and article text (body of article) including past received article and is used for selecting and determining the natural language at the time of performing the statistical processing of the access history.

Furthermore, in the data base server section 4, as user informations, there are stored a user ID as personal information of a client, name of user and interested article receiver address (URL, mail address or like).

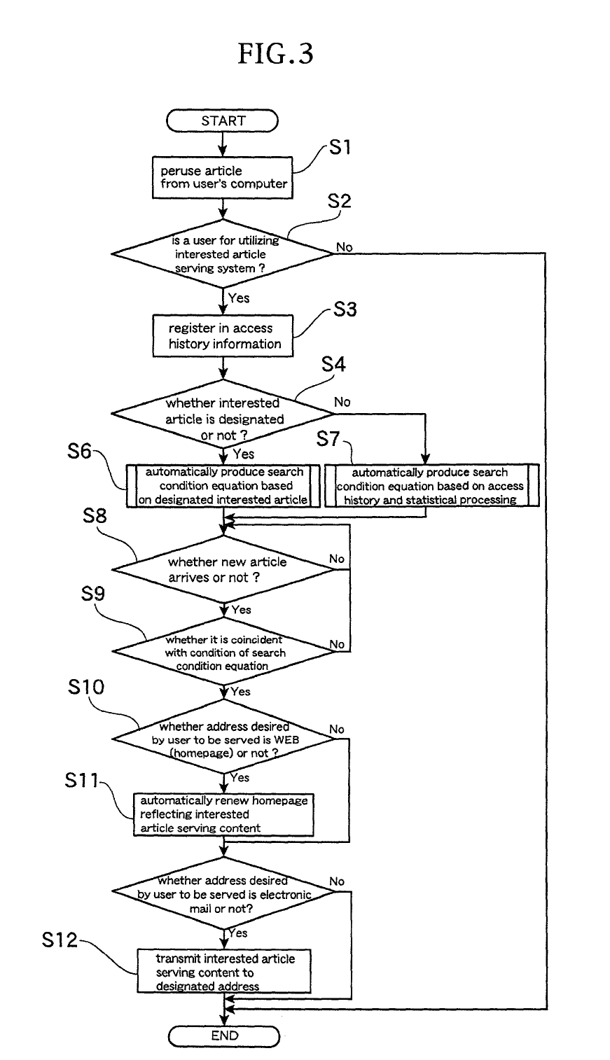

The interested article serving system of the structures and characters mentioned above will be used by a method, which is described hereunder with reference to FIGS. 3 to 5.

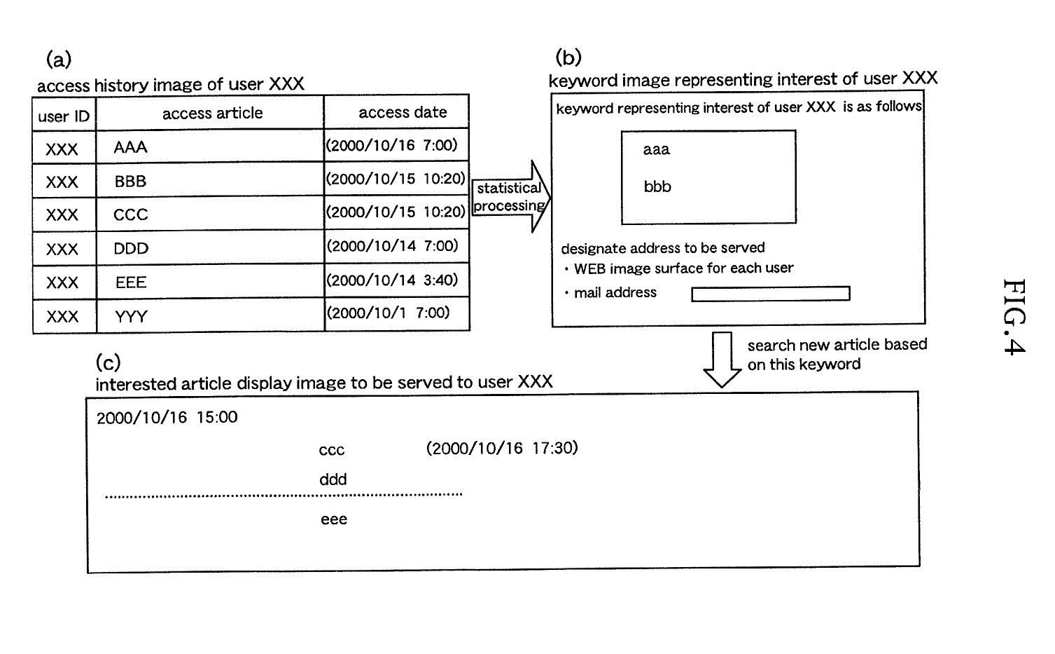

FIG. 3 is a flowchart showing procedures in a case of using the interested article serving system of FIG. 1 of the present invention and FIG. 4 includes image views of the client device in such interested article serving system.

First, when the client wants to peruse an article or articles, the client device 7 is connected to the internet 8 to access a Web-page (homepage) on which an interested article is described (Step S1). Next, when the article is perused by the client, the server device 1 obtains a personal information and access history of the client through the WWW server section 2.

Next, in accordance with the obtained personal information of the client, it is investigated whether this client is a client who wants to use an interested article serving system through the reference to the user information (Step S2). The user information necessarily includes an information for discriminating or judging the client and an interested article serving address or like as precipitation concerning items, and there is no specific precipitation or provision concerning informations or like other than the above.

As a result of the investigation, this client is a client who wants to use the interested article serving system, an access history is registered in the data base server section 4 (Step S3). It will be necessary for the access history to include full text (all sentences) of the accessed article, an information specifying the article such as information indicating a position of the article, time or day on which the article is accessed, or an information whether a related article designation has been made or not.

In the case where the position of the article is made as an information specifying the article, an information corresponding to the article text (body of article) is required. The access history is not limited to the article text and title or abstract of the article may be otherwise utilized.

For the information concerning the related article designation, only an interest automatically extracting function from the access history is needed, and such information is not needed in these of no related article designation function.

Next, it is investigated, at the client peruse time, whether that article is designated or not as an interested article from the access history (Step S4). In the case of no related article designation function, it is not necessary to confirm the perusal content.

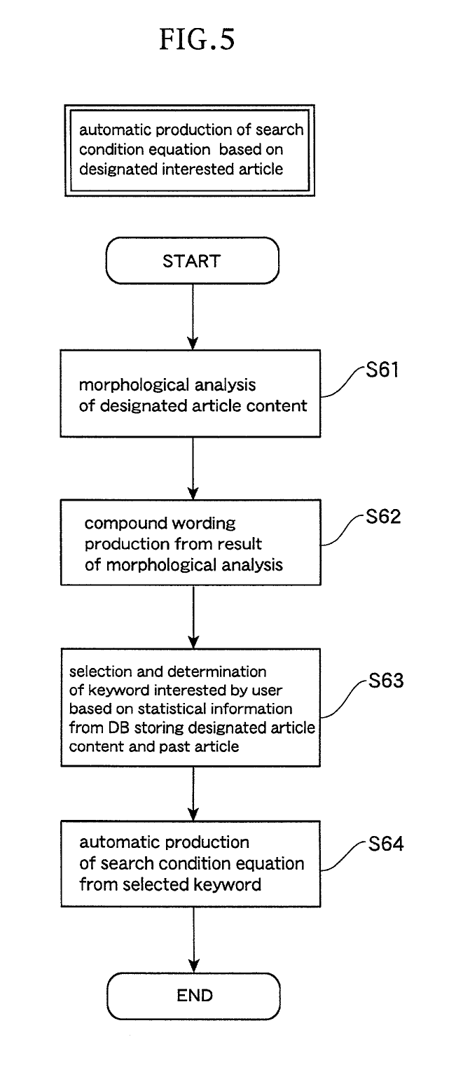

As a result of confirmation of the perusal content, in the case of being designated as interested article, the search condition equation 12 is automatically produced from the content of the article (Step S6). The procedure for automatically producing the search condition equation from the designated article content is represented by the flowchart of FIG. 5, which will be described in detail hereinlater.

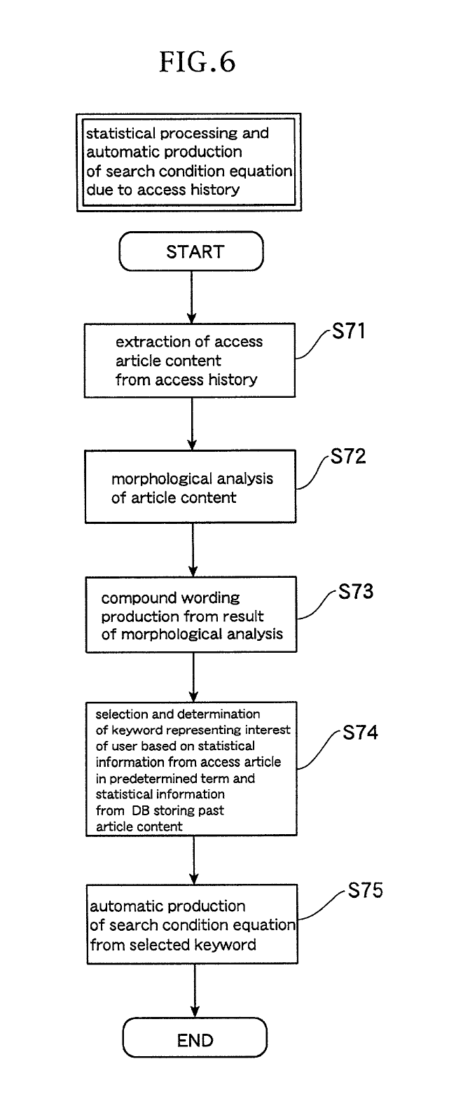

On the other hand, in such confirmation result, in the case of being not designated as the interested article, the statistical processing from the access history is executed and the search condition equation 12 is renewed (Step S7). The procedure for performing the statistical processing of the access history and automatically producing (renewing) the search condition equation 12 is represented by the flowchart of FIG. 6, which will be described in detail hereinlater.

After the completion of the automatic production of the search condition equation 12 and the statistical processing of the access history, it is investigated whether a new article (object) to be served exists or not (Step S8).

In the case of the existence of the new article, the full text search is executed to investigate whether the new article accords with the search condition equation 12 of the client (Step S9). In the case where the new article does not accord with the search condition equation 12 of the client, the step proceeds to further investigate whether next new article exists or not.

On the other hand, in the case where the new article accords with the search condition equation 12 of the client, the user information in the data base server section 4 is referred to investigate whether a serving address designated by the client is the Web-page (homepage) or electronic mail (Step S10). At this interval, it may be possible to display, to the client device 7 used by the client, an image designating a serving address (an address to which it is desired for the article to be served) shown at the lower portion of (b) in FIG. 4.

As a result of the investigation, in the case where the serving address is the Web-page (homepage), the homepage considering the content of the interested article to be served is automatically renewed (Step S11). On the other hand, in the case where the serving address is the electronic mail, the content of the interested article is transmitted to the designated mail address (Step S12). Then, on the client device 7 receiving the interested article, an interested article display image such as shown in (c) in FIG. 4 appears.

Further, it is to be noted that chracters or symbols AAA, BBB, —YYY, aaa, bbb— and like are mere characters or symbols which represent matters to be substituted with other ones as occasion demands.

Next, the procedure for the automatic production of the search condition equation 12 in the case where the client designates the interested article will be described with reference to the flowchart of FIG. 5.

As shown in the flowchart of FIG. 3, as a result of the perusal content confirmation, in the case where the perused article is designated as an interested article, the search condition equation 12 is automatically produced from the content of that article (Step S6).

In this case, the article designated by the client is divided into units of parts through, for example, morphological analysis to thereby obtain part information (Step S61). Next, the natural languages divided into the units of parts are subjected to compound wording processing for, for example, combining continuous nouns to thereby produce a compound wording (Step S62). According to the preparation of such compound wording, it is possible to avoid expression from being abstracted due to the division of the natural language, and it becomes possible to select and determine the search keyword surely representing the interest of the client (Step S63).

Upon the determination of the search keyword, the search condition equation 12 (consisting of search keyword, weight, scoring system, etc.) for searching the document concerning the designated article content on the basis of this search keyword is automatically produced (Step S64).

A system for counting a score at a time of appearance, even one time, in the article to be searched, or a system for counting scores every time of appearance therein may be listed up as such scoring system.

Hereunder, there will be described conditions for selecting and determining part informations concerning the search keyword selection, number of document on which natural language appears and generality of natural language.

The natural languages of the parts representing characteristics such as compound wordings, nouns, undefined wordings, etc. are extracted from the part informations. The parts to be extracted are not limited to the compound wordings, nouns, and undefined wordings mentioned above and designate the parts which are estimated to represent the characteristics to every document to be served. After the division into the units of parts, it may be possible, as occasion demands, to add functions of reserving or storing the natural languages, as a list, which should be deleted, and deleting such natural languages even if they are the parts to be extracted.

According to the part information, weight with respect to squeezed natural language is calculated from the significancy representing the appearing number of the natural language and the generality thereof.

The natural languages which appear frequently are considered to be natural languages representing the concept of that article. The significancy representing the generality of the natural language will be obtained, for example, by calculating a ratio of articles in which such natural language appears in the data base storing various articles. In the case where this ratio is large, the significancy is small because this natural language is one appearing in various articles, and on the other hand, in the case where this ratio is small, the significancy is large because this natural language is one appearing in certain specific article. Further, although a usual natural language may be deemed as one appearing frequently, such natural language has a small significancy as natural language and a weight applied to that natural language becomes small, and accordingly, such usual natural language will give less adverse influence to the searched result.

Next, procedure in the case where the client does not designate an article as a document having an interest will be described hereunder with reference to the flowchart of FIG. 6.

In a result of the confirmation of the perusal content, in a case of not being designated as an interested article, as shown in the flowchart of FIG. 3, the statistical processing is performed from the access history of the client and the search condition equation 12 is automatically produced (Step S7).

In such case, a content of the accessed article of the client is extracted from the access history of the client (Step S71). In the case where the article text (body of article) is stored in the access history, the article text will be extracted. Further, in the case where the information stored in the access history is not the article text and this information is an information for specifying the article such as position of the article, the article content will be extracted from the corresponding information between the information specifying the article and the article text.

Next, the accessed article is divided into units of parts through, for example, the morphological analysis to thereby obtain part information (Step S72). Then the natural languages divided into the units of parts are subjected to the compound wording processing for, for example, combining continuous nouns to thereby produce a compound wording (Step S73). According to the preparation of such compound wording, it is possible to avoid expression from being abstracted due to the division of the natural language, and it becomes possible to select and determine the search keyword surely representing the interest of the client (Step S74).

Upon the determination of the search keyword, the search condition equation (consisting of search keyword, weight, scoring system, etc.) for searching the article concerning the designated article content on the basis of this search keyword is automatically produced (i.e. renewed) (Step S75). The weight will be calculated, for example, from the appearing number and the significancy of the natural language. Further, a system for counting a score at a time of appearance, even one time, in the article to be searched, or a system for counting scores every time of appearance therein may be listed up as such scoring system.

Hereunder, there will be explained the part informations concerning the search keyword determination in the step S74, the number of documents in which the natural language appears and the conditions for selecting the generality of the natural language. In these items, explanations concerning the selection condition of the part information are substantially the same as those in the case where the client designates the interested article.

According to the part information, for the natural languages appearing in a plurality of articles in the accessed articles, only the natural languages commonly appearing in the articles which number exceeds a predetermined threshold value as a concept interested by the client. In this operation, it is an important matter not to consider the appearing frequency of the natural language for each article.

In the next procedure, in order to further squeeze these once squeezed natural languages only to further characteristic natural languages, natural languages appearing in various articles are excluded. For this purpose, for example, the ratio of the articles including the natural language appearing in the data base server section 4 is calculated, and in this calculation, the natural language appearing in articles over or below the predetermined threshold value in frequencies is considered to be general and then excluded. According to such procedures, the natural language which has characteristics and is squeezed will be deemed as the search keyword representing the interest of the client, thus obtaining the search result having less noise.

In a plurality of articles, since notational variant deviation or like causes to every article, concerning the natural language locally coincident with the extracted search keyword in the excluded natural language, a function that such natural language is deemed to be also a search keyword may be added.

Further, it is to be noted that the present invention is not limited to the described embodiments and many other changes and modifications may be made without departing from the scopes of the appended claims.

That is, for example, in the embodiment described above, although the internet 8 constitutes a connection means, another network such as specific (selected) circuit means connectable to the WWW server section 2 may be utilized. Further, the WWW server section 2 is allowed to be only provided with a function for managing the articles, in one-way, to be served to the client in a system capable of grasping the information peruse or perused history of the client or capable of designating the articles interested by the client, and hence, such server section is not necessarily always connected to the internet.

Furthermore, the WWW server section 2, the electronic mail server section 3 and the interested article extraction server section 4 explained hereinbefore as elements constituting the server device 1 may have respectively independent structures.

Further, in a modified service example, one or both of the WWW server section 2 and electronic main server section 3 may not be disposed to the same location in arrangement as the interested article extraction server section 4 as far as it or they are connected through a network or like.

Further, the electronic mail server section 3 may be eliminated from the construction in a case where the mail service is not performed.

Furthermore, the access history, the article contents and the user informations may be constituted by files having no specific data base construction such as data base controlled by a specific software such as respectively independent data base control system or data base control system.

The article production computer 9 may be allowed to only have a function for distributing a newly generated article to the server device 1 through the same network or file transfer from a remote place, or may be commonly utilized with the server device 1.

What is claimed is:

1. An interested article serving system in which a client device and a server device serving an information in accordance with a request from the client device are connected through a network system, said server device comprising:
a WWW server section operating in response to the requirement from the client device;
a data base server section storing personal information and access history of a client using the client device;
an interested article extraction server section analyzing the access history of the client stored in the data base server section and then producing a search condition equation; and
a superparallel computing means searching article data swquentially fed from an external article producing computer in accordance with the search condition equation produced in the interested article extraction server section,
wherein a plurality of different search condition equations are set individually on a plurality of different processors of said superparallel computing means, said article data is subjected to full text search and a result coincident with said search condition equations is transmitted to said client device.

2. An interested article serving system according to claim 1, wherein said article data is received from an external article production computer other than said server device.

3. An interested article serving system according to claim 1, wherein said access history is accumulated for each of clients and when the client accesses a plurality of articles, in a plurality of times, resembling in contents as the access history, a natural language included in said plurality of articles having resembling contents is used as a search keyword of said search condition equation.

4. An interested article serving system according to claim 1, wherein said access history is accumulated for each of clients and when the client accesses a plurality of articles, in a plurality of times, different in contents as the access history, constant number of articles or number of articles which are accessed in a constant term is determined as reference number of articles, and same natural languages appearing in a plurality of articles having different contents in said reference number of articles are used as a search keyword of said search condition equation.

5. An interested article serving system according to claim 4, wherein said search condition equation adopts a characteristic natural language as said search keyword which is weighed by number of appearance of the natural language in the specified article data designated by the client and a ratio of appearance of said natural language in a plurality of articles included in the access history of the client.

6. An interested article serving system according to claim 1, wherein said access history is accumulated for each of clients and when the client designates a specific article data as the access history, a natural language included in said specific article data is used as a search keyword of said search condition equation.

7. An interested article serving system according to claim 1, wherein said client device is a portable terminal device.

8. An interested article serving system according to claim 7, wherein said portable terminal device is a portable telephone.

9. An interested article serving method using a serving system in which a client device and a server device serving an information in accordance with a request from the client device are connected through a network system, said serving method comprising the steps of:
analyzing an access history of a client using the client device and then producing a plurality of different search condition equations;
setting said plurality of different search condition equations independently on a plurality of different processors included in a superparallel computer means;
searching simultaneously parallelly a full text of an article data subsequently fed from an external article producing computer with said plurality of different search condition equations; and
serving a result which coincident with the search condition equation to the client device.
